(19) United States
(12) Patent Application Publication
(10) Pub. No.: US 2013/0311668 A1
(43) Pub. Date: Nov. 21, 2013

(54) Methods And Systems For Providing Fairness And Stability To Video Streams

(71) Applicants: Shahid Akhtar, Collin, TX (US); Andrea Francini, Iredell, NC (US)

(72) Inventors: Shahid Akhtar, Collin, TX (US); Andrea Francini, Iredell, NC (US)

(21) Appl. No.: 13/686,838

(22) Filed: Nov. 27, 2012

Related U.S. Application Data
(60) Provisional application No. 61/647,280, filed on May 15, 2012.

(51) Int. Cl. H04L 29/06

(52) U.S. Cl. CPC H04L 65/60
USPC 709/231

(57) ABSTRACT

Methods and related systems for providing fairness and stability to video streams are presented that involve the adjustment of committed information rates and priority levels associated with video streams.

### RELATED APPLICATION

This application is related to, and claims the benefit of priority from, U.S. Provisional Application No. 61/647,280 filed May 15, 2012 whose teachings and contents, including the text and drawings, is incorporated by reference herein in its entirety, as if set forth in full herein.

### BACKGROUND

Many techniques are used to deliver content (e.g., video and audio) over data networks from a source to a destination. One technique is referred to as so-called http adaptive streaming (HAS). A source may be a content delivery network (CDN) system while a destination may be a device within a residential home, commonly referred to as a “client” or client side device. Many times a residential home may have a number of clients connected to a data network, all of which may be receiving data over a HAS stream or an Internet stream. Together, a home's HAS and Internet streams comprise an “access link”. Usually a residential home is allotted a given committed information rate (CIR) by an access device (e.g., a border network gateway (BNG)) that acts as an intermediary between the CDN system and the client-side devices (collectively the devices may be referred to as a “system”). In essence, the CIR places a limit or constraint on how much data can be delivered by the CDN system via the access device to the client-side system within a given time period. Said another way, for a given CIR, there is an associated, maximum bandwidth available to all of the client-side devices.

Given a particular CIR, one or more of the client-side devices may compete for a share of the available bandwidth. In some cases, one (or more) of the client-side devices may use far more of the bandwidth than other devices. When this occurs such a device (“preferred device”) is said to be “unfairly” using more of the bandwidth than the other devices. This unfairness may result in a degradation of the content being delivered to the client-side devices that are forced to use the bandwidth that remains after the preferred device has used its portion of the available bandwidth.

Accordingly, it is desirable to reduce unfairness between video streams, among other desires.

### SUMMARY

The amount of unfairness may be reduced by a method that comprises: receiving packet loss rate information, at a HAS originating system, associated with an Internet traffic queue; sending a message from the HAS originating system, to an access device, to adjust a CIR associated with a HAS traffic queue and the Internet traffic queue. In embodiments of the invention the access device may comprise a BNG, digital subscriber line access multiplexer (DSLAM) or a fiber-to-the-home (FTTH) node while the HAS originating system may comprise a CDN delivery server, origin server or DVR node, for example. The method may further comprise adjusting the CIR associated with the HAS traffic queue and Internet traffic queue at the access device. Yet further, the method may comprise: receiving the message to adjust the CIR at the access device; comparing an adjusted CIR to an available CIR associated with the HAS traffic queue and Internet traffic queue at the access device; maintaining a stored, current CIR when the comparison indicates the adjusted CIR exceeds the available CIR; and sending a message indicating that the access device cannot meet the adjusted CIR to the HAS originating system.

An additional method for reducing the amount of unfairness between video streams is directed at adjusting the priority associated with a client video stream within a HAS video stream. In particular, such a method may comprise: receiving a message comprising a requested video quality (VQ) level for a client video stream within a HAS video stream, at a HAS originating system, from a client side system, for example; applying a desired bandwidth notch percentage to a desired VQ value associated with the HAS video stream to determine a desired bandwidth, notch percentage factor; determining a threshold VQ level from the desired bandwidth, notch percentage factor; comparing the requested VQ level to the threshold VQ level; and adjusting a priority assigned to the client video stream when the comparison indicates that the requested VQ level is at, or below, the threshold VQ level. The method may further comprise increasing the priority assigned to the client video stream when the comparison indicates that the requested VQ level is at, or below, the threshold VQ value. Yet further, the method may comprise selecting a desired bandwidth, notch percentage from a plurality of fractional values, wherein the fractional values are selected from a range of 0.0 to 1.0.

The priority-based methods discussed above may be varied to avoid instability between client video streams due to unexpected effects that may occur when the priority of a given client video stream is adjusted. In embodiments of the invention the priority based methods may additionally include a “smoothing” feature. In more detail, rather than adjust the priority assigned to, or associated with, an entire client video stream, some packets within a “chunk” of such a stream may have their priority adjusted while other packets within the chunk may not have their priority adjusted.

In particular, an additional method for adjusting a priority associated with a client video stream within a HAS video stream that includes such a smoothing feature may comprise: receiving a message, at a HAS originating system for example, comprising a requested VQ level for a client video stream comprising a plurality of portions within a HAS video stream; comparing the requested VQ level to a desired bandwidth, notch percentage factor; and adjusting a priority assigned to some packets within each portion of the client video stream from a first assigned priority to a second assigned priority based on the comparison.

Yet further, the method above may further comprise sending the packets having the second assigned priority to an access device after a round trip delay period has elapsed. That is, packets having the first assigned priority may be sent to an access device, and, thereafter packets having the second assigned priority may be sent to the access device after a round trip delay period has elapsed. This helps avoid a situation where the packets with the second assigned priority arrive at the access device before the packets assigned with the first priority (i.e., out of order). This may occur when the packets having the second priority experience a shorter delay than the first priority packets or when the packets associated with the second priority traverse a path that is less congested than the path traversed by packets associated with the first priority. At the access device, the device may be operable to receive the packets having the first assigned priority and, may be further operable to receive the second assigned priority after a round trip delay period has elapsed.

Additional methods for reducing the amount of unfairness between HAS video streams are directed at adjusting a CIR rate. In particular, one method comprises: measuring a total throughput associated with one or more HAS video streams of an access link, at a HAS originating system, for example; determining a threshold VQ level for each of the one or more HAS video streams based on a desired VQ quality level for each HAS video stream and a current, desired bandwidth notch percentage; summing the determined, threshold VQ levels to determine a total threshold bandwidth for the one or more HAS video streams of the access link; comparing the total, measured throughput to the total threshold bandwidth; determining a next, threshold VQ level for each of the one or more HAS video streams based on a desired VQ quality level for each HAS video stream and a next desired bandwidth notch percentage, wherein the next desired bandwidth notch percentage is greater than the current desired bandwidth notch percentage, when the comparison indicates that the total, measured throughput is greater than the total threshold bandwidth; summing the next determined, threshold VQ levels to determine a next, total threshold bandwidth; comparing the total, measured throughput to the next, total threshold bandwidth; and sending a message, to increase the CIR for the one or more HAS video streams associated with the access link to a level equal to the total threshold bandwidth. The method may be continuously repeated if the total throughput is less than the total threshold bandwidth. For example, a further method may comprise: continuing to determine a threshold VQ level for each of the one or more HAS video streams based on the desired VQ quality level for each HAS video stream and a next, highest desired bandwidth notch percentage, wherein the next, highest desired bandwidth notch percentage is greater than the current desired bandwidth notch percentage, when the comparison indicates that the total, measured throughput is greater than the determined, total threshold bandwidth; continuing to sum the determined, threshold VQ levels to determine a next, total threshold bandwidth, when the comparison indicates that the total, measured throughput is greater than the determined, total threshold bandwidth; and continuing to compare the total, measured throughput to the next, total threshold bandwidth, when the comparison indicates that the total, measured throughput is greater than the determined, total threshold bandwidth.

Yet another method for adjusting a CIR comprises: receiving, at a HAS originating system, packet loss rate information that indicates a packet loss rate associated with an access device, traffic queue (e.g., Internet traffic queue); comparing the packet loss rate to an elevated rate; comparing the packet loss rate to an estimated, maximum rate when the received packet loss rate is greater than the elevated rate; reducing a current desired bandwidth notch percentage to a reduced, desired bandwidth notch percentage when the packet loss rate is greater than, or equal to, the elevated rate, but less than the estimated, maximum rate; determining a reduced, threshold VQ level for one or more HAS video streams of an access link associated with the access device based on a desired VQ quality level for each of the HAS video streams and the reduced, desired bandwidth notch percentage; summing the determined, reduced threshold VQ levels to determine a total, reduced threshold bandwidth; and sending a message, to decrease a CIR associated with the access link for a HAS traffic class that includes the HAS video streams to a level equal to the total, reduced threshold bandwidth. Rather than adjust a current desired bandwidth notch percentage to a reduced, desired bandwidth notch percentage in an additional embodiment the current desired bandwidth notch percentage may be reduced to a minimum, desired bandwidth notch percentage when the packet loss rate is greater than or equal to the elevated rate, and the estimated, maximum rate. Thereafter this method may comprise: determining a minimum, threshold VQ level for one or more HAS video streams of a given access link based on a desired VQ quality level for each of the HAS video streams and the minimum, desired bandwidth notch percentage; summing the determined, minimum threshold VQ levels to determine a total, minimum threshold bandwidth, notch percentage; sending a message, to decrease a CIR associated with the given access link to a level equal to the total, minimum desired bandwidth, notch percentage, for the HAS video streams.

The above methods may be completed by the combination of a HAS originating system, access device and client side system. Further, such methods may be completed, and or used, in conjunction with additional methods involving a customer portal system (“portal” or “portal system” for short). Such a portal may comprise both a client side portion and a network side portion. In addition to the above-described methods, the portal may be operable to complete a method that comprises: selecting a VQ level for a client video stream within a HAS video stream, wherein the selected VQ level is above a minimum VQ level; and sending a message comprising the selected VQ level to a HAS originating system, wherein the system guarantees the selected VQ level. Alternatively, a second method may comprise: selecting the minimum VQ level for the client video stream within the HAS video stream; and sending a message comprising the selected, minimum VQ level to the HAS originating system, wherein the system guarantees the selected minimum VQ level. Yet a third method may comprise: selecting a VQ level similar to Internet traffic for the client video stream; and sending a message comprising the selected VQ level similar to the Internet traffic to the HAS originating system. Again, the HAS originating system may be operable to guarantee the selected VQ level.

### BRIEF DESCRIPTION OF THE DRAWINGS

FIG. 1 depicts a simplified block diagram of a system according to an embodiment of the present invention.

FIG. 2 depicts a simplified diagram of message flows between components of the system in FIG. 1, for example, according to an embodiment of the present invention.

FIGS. 3 and 4 depict exemplary VQ levels used to illustrate methods for adjusting the priority associated with client video streams within one or more HAS video streams according to embodiments of the present invention.

### DETAILED DESCRIPTION, WITH EXAMPLES

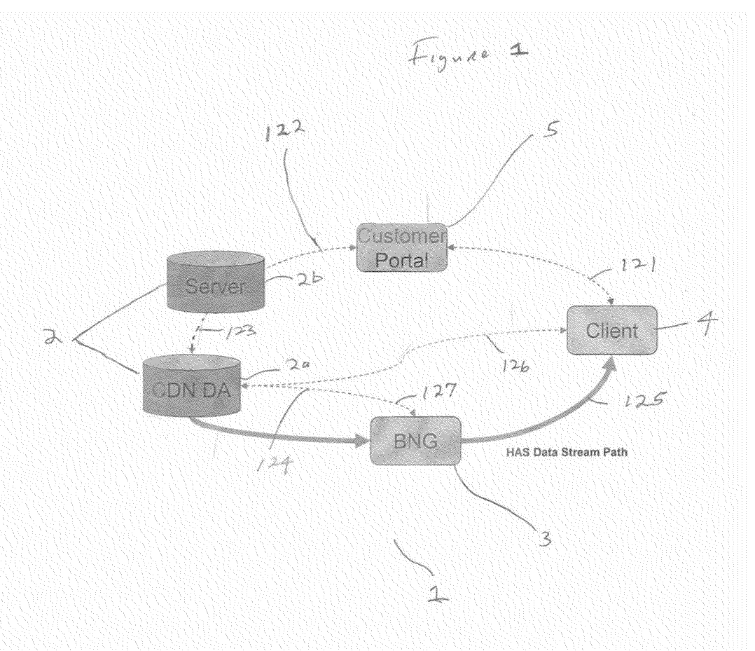

Referring to FIG. 1, there is shown a simplified diagram of a CDN system 1 for providing fairness and stability to video streams according to one embodiment of the present invention.

In more detail, system 1 may comprise a HAS originating system 2. The system 2 may comprise a CDN delivery agent 2a (CDN-DA) (“delivery agent”) and a delivery server or origin server 2b, access device 3, destination or client-side system 4, and customer portal system 5. Though FIG. 1 depicts some components of the system as being single, separate components, it should be understood that each component may comprise multiple components and one or more of the components may be combined into one component. For example, the functions of delivery agent 2a and server 2b may be combined into a single component. In additional embodiments of the invention the HAS originating system 2 may comprise a specialized, origin server with stored or cached content or a digital video recorder (DVR) node. Typically, the HAS originating system 2 may complete functions associated with content delivery, including file accessibility, application processing, multimedia delivery and caching. In one embodiment of the invention, the system 2 may receive requests for content (e.g., videos) from a user or client-side system 4 and may send requests for such content to upstream origin servers (not shown). Upon receiving content from an upstream server, the system 2 may store or cache the content and then, when requested by a client-side system 4, may send the content (as well as associated metadata) on to the client-side system 4. In accordance with the present invention, system 2, as well as the other components shown in FIG. 1, may be operable to complete additional, specialized functions related to providing increased fairness and stability among video streams.

The system 2 (either delivery agent 2a and/or delivery server 2b) may be operable to store a number of parameters and data associated with each stream within a given access link. For example, the system 2 may store the following information: stream ID (internal tracking number); IP address of client (part of stream identification); port number (part of stream identification); protocol (e.g., TCP/UDP); DSCP Class (i.e., the IP Network QoS class to be used for a given HAS stream); minimum VQ; maximum VQ; desired VQ; and a stream inactivity timer (checked when a stream becomes idle).

It should be understood that system 1 may be part of a larger CDN system made up of similar systems and nodes like system 1 distributed over multiple, sometimes distant locations. In such an example, each of the systems or nodes may assist each other in completing end-user or client-side content requests to optimize the process of delivering content to a client/end-user. The number of components, nodes, servers, etc., participating to form a particular CDN system varies with respect to the network architecture.

Referring back to FIG. 1, the access device 3 may comprise a BNG, DSLAM or a FTTH, for example. Alternatively, the access device 3 may comprise one or more edge routers. In these embodiments, the access device 3 may be operable to control the CIR and bandwidth allocated to a specific client-side system 4 (e.g., user, subscriber, residence). Regarding the client-side system 4, such a system may comprise one or more client-side devices typically found in a home or business, such as a desktop computer, laptop computer, tablet, wireless device, etc. that are operable to run one or more programs or applications that enable the reception of content (e.g. HAS video streams). The portal 5 may comprise a combination of client-side and network-side components/devices that are operable to complete the features and functions described above and below. In one embodiment of the invention the portal 5 may comprise a network-side server that is operable to host one or more http web page(s), and a client-side device (e.g., desktop, laptop computer, tablet, smart phone, etc.,.) that may also be a part of system 4 and operable to access the web pages in order to provide a user of the client-side device with control of the VQ of HAS video streams.

In general, each of the components depicted in FIG. 1 may comprise one or more processors and memory devices. Each of the processors may be operable to access executable instructions stored in one or more associated program memories to manage the various operations of a particular component 2 through 5 and to perform various functions, including processing content. A processor may be implemented as, for example: one or more programmable digital signal processors, programmable microprocessors, multiple programmable controllers or specialized circuitry. A memory may comprise any suitable recordable medium or storage medium capable of storing content, signaling messages, executable instructions and programs that can be accessed and executed by the processors. For example, a memory may take the form of RAM, ROM, cache memory, and/or external or internal mass storage media of a mass storage unit.

Each of the components shown in FIG. 1 may also, and typically will, comprise other additional known circuitry, such as power supplies, clock circuits, input/output (I/O) circuitry, displays and the like, as well as specialized circuits that may be used in conjunction with a processor to complete functions in accordance with executable instructions and programs stored in a memory. The I/O circuitry may be used to form interfaces between the various components shown in FIG. 1. In general, the operation of this additional circuitry is well known and a detailed discussion of such circuitry is not required for an understanding of the present invention. For the sake of conciseness, therefore, the operation of this circuitry is not included herein.

Also shown in FIG. 1 are pathways 121 through 127. The pathway 125 may be referred to herein as an access link, end customer access link or end-user access link. It should be understood that messages exchanged between components 2 through 5 may be sent over pathways 121 through 127.

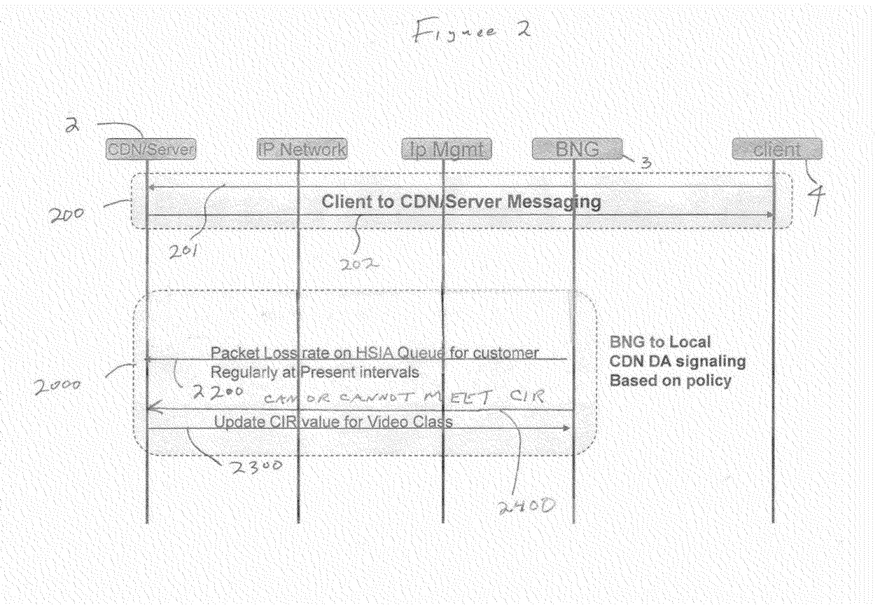

Referring now to FIG. 2, there is depicted a simplified diagram of exemplary message flows 200, 2000 and some, associated exemplary messages 201, 202 and 2200, 2300 and 2400 making up the flows 200, 2000 that may be exchanged between components of the system 1 according to embodiments of the present invention. In general, the messages depicted in FIG. 2 may be referred as “signaling” messages because they contain information used to instruct a component to complete a particular function, as opposed to simply containing content. It should be understood that the message flows 200, 2000 and signaling messages 201, 202 and 2200, 2300 and 2400 depicted in FIG. 1 are only a few of the many signaling message flows and associated messages that may be exchanged between components of system 1. For the sake of conciseness, the message flows and messages related to the present invention are primarily the ones discussed herein. Though shown as a distinct number of separate message flows and/or messages, it should be understood that one or more of the message flows and/or messages shown in FIG. 2 may be combined into fewer message flows and/or messages or further broken down into additional message flows and/or messages.

FIGS. 1 and 2 may be utilized to help explain one method for providing increased fairness and stability for video streams. In one embodiment of the invention this may be achieved by adjusting a CIR for HAS and Internet queues within access device 3. Such a method may include receiving a message 2200 at the system 2 that includes at least packet loss rate information associated with an Internet traffic queue within access device 3 that is associated with access link 125. Upon receiving the message 2200, the system 2 may be operable to compute an adjusted CIR, if required, based at least upon the packet loss rate information, and then send a message 2300 to the access device 3 to adjust a CIR associated with the HAS and Internet queues by, for example, an amount specified within the message 2300. The access device 3 may be operable to receive such a message and make the adjustment to the CIR or send a responsive message 2400 to the system 2 that such an adjustment cannot be made. In slightly more detail, the access device 3 may be operable to send the message 2400 to the system 2 after analyzing the available CIR associated with the HAS and Internet efforts queues.

In even more detail, upon receiving the message 2300 to adjust the CIR, the access device 3 may be further operable to compare the adjusted CIR to an available CIR associated with HAS queues and Internet queues associated with the access link 125. If such a comparison indicates that the adjustment cannot be made, because, for example, the adjusted CIR may exceed an available CIR allotted to the HAS and Internet queues the access device 3 may be operable to send a message 2400 indicating that the access device 3 cannot meet the adjusted CIR to the system 2 (e.g., to delivery agent 2a). In such an instance the access device 3 may be operable to maintain a stored, current CIR. Conversely, if the comparison indicates that the adjustment can be made, because, for example, the adjusted CIR does not exceed the available CIR, the access device 3 may be operable to send the message 2400 indicating that the access device can meet the adjusted CIR to the system 2 (e.g., to delivery agent 2a). In such an instance the access device 3 may be operable to adjust a stored, current CIR using an amount specified within the message 2300, for example.

In addition to message flow 2000, FIG. 2 also depicts message flow 200. In an additional embodiment of the invention the flow 200 may comprise one or more messages 201, 202 exchanged between the system 2 and the client-side system 4. As will be explained further below, in one embodiment of the invention the client-side system 4 may send at least a desired VQ value within message 201 to the system 2 via, for example, pathway 126 in FIG. 1 directly, and/or via a portal 5. The message 201 allows a client-side system, and in particular the user of a device within the system 4, to at least specify a desired VQ value for individual HAS streams as well as packets within an individual “chunk” or portion of a HAS video stream (hereafter “chunk” and “portion” may be used interchangeably) the user wishes to be delivered from the system 2 to the client-side system 4. In an alternative embodiment, instead of waiting for a message from the client-side system 4, the system 2 (e.g., agent 2a and/or server 2b) may be operable to send a message 202 to the client-side system 4 requesting a desired VQ for a client video stream, or chunk, within a HAS video stream from the client-side system 4. In response, the system 2 may forward a message similar to message 201 described above.

The present invention provides methods for enabling a user to easily communicate VQ values and other additional information to the system 2 so that, for example, a VQ level associated with one or more client video streams (or portions thereof) within a HAS video stream can be adjusted. In one embodiment such a method comprises selecting a VQ level for each client video stream within a HAS video stream at the client-side system 4, in particular, via a client-side device that is a part of the customer portal 5, and sending a message comprising the selected VQ levels to a network-side server making up a part of portal 5 as well, and, thereafter, to system 2, for example. In the example above, it was noted that the client-side system 4 sends a message 201 to the system 2 requesting a desired VQ value/level, where the client-side device making up the portal 5 may be a part of the system 4.

In more detail, in one embodiment of the invention a user of a client-side device making up portal 5 may be operable to select a VQ level for a client video stream within a HAS video stream, wherein the selected VQ level is above a minimum VQ level. After making such a selection the client-side device may be operable to send a message comprising the selected VQ level to the network-side device of portal 5 which may be a part of the HAS originating system 2, for example. Upon receiving the message, the system 2 may be operable to guarantee the selected VQ level. Alternatively, instead of selecting a VQ level that is above the minimum level, the user may select the minimum VQ level for the client video stream within the HAS video stream. Similarly, the client-side device making up portal 5 may be operable to send a different message to system 2 that comprises the selected, minimum VQ level to the HAS originating system, whereupon the system 2 may be operable to guarantee the selected, minimum VQ level. Yet further, a user may decide not to adjust the VQ level of a client video stream at all. Instead, the user may select a VQ level that is similar to a quality of service level associated with Internet traffic for the client video stream, and, thereafter send a message, comprising the selected VQ level similar to the quality of service level associated with Internet traffic, to the HAS originating system.

Discussions above focused on increasing fairness and stability by adjusting the CIR, for example, based on the receipt of packet loss rate information. In yet additional embodiments of the invention, VQ values communicated to the system 2 may be used to adjust the CIR at the access device 3 to provide increased fairness and stability to video streams.

As is known by those skilled in the art, the VQ level of a client video stream, or a portion thereof, within a HAS video stream may be modified prior to the time that the streams or portion is delivered from the system 2 to the client-side system 4. Further, it is also known that upon initialization, an initial VQ level may be automatically selected. Thereafter, however, the VQ of a given client video stream, or portion therein, within a HAS video stream may be adjusted.

In accordance with an embodiment of the invention, fairness and stability among video streams may be increased by adjusting the priority associated with a client video stream, or a portion therein, within a HAS video stream upon receiving a requested VQ value.

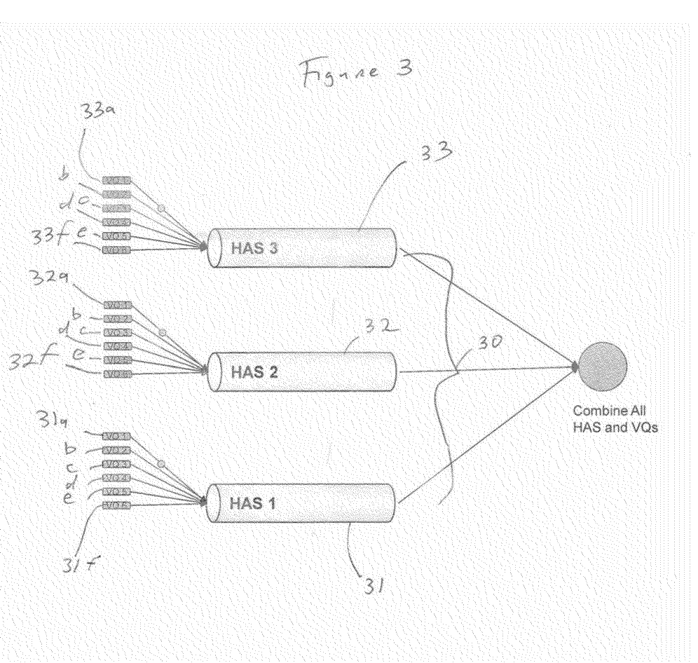

Referring to FIG. 3, there is depicted an exemplary illustration of VQ levels related to adjusting the priority associated with a client video stream within a HAS video stream according to embodiment of the present invention. FIG. 3 depicts an access link 30 that comprises three HAS video streams 31 through 33. In accordance with an embodiment of the invention, a plurality of VQ levels may be associated with each client video stream 31-33. For example, HAS video stream 31 may be associated with VQ levels 31a through 31f, HAS video stream 32 may be associated with VQ levels 32a through 32f, and HAS video stream 33 may be associated with VQ levels 33a through 33f. In accordance with an embodiment of the invention, fairness and stability among video streams may be increased by adjusting the priority of one or more of the client video streams (and their associated VQ level) to ensure that the bandwidth of an adjusted client video stream is maintained at a rate associated with a minimum VQ level. By doing so, the bandwidth of the adjusted client video stream(s) is guaranteed not to fall below a rate associated with a minimum VQ level.

In more detail, the following description sets forth a method for adjusting the priority associated with a client video stream within a HAS video stream according to one embodiment of the invention. To begin, the system 2 may be operable to receive a message (e.g., message 201 shown in FIG. 2) comprising a requested VQ value or level for a client video stream within a HAS video stream (e.g., stream 31, 32 or 33) from the client-side system 4. For each client video stream, a separate message may be received at the system 2. Upon receiving each requested VQ value the system 2 may be operable to compare each requested VQ level to a minimum VQ level to identify a client video stream within each HAS video stream whose priority should be adjusted. When a given comparison indicates that a requested VQ level, associated with a given client video stream within a HAS video stream, equals a minimum VQ level, then the system 2 may be further operable to adjust a priority assigned to the client video stream associated with the requested VQ level that equals the minimum VQ level to ensure that the bandwidth of the client video stream is maintained at a rate associated with the minimum VQ level. More particularly, the system 2 may be operable to increase the priority assigned to the identified client video stream when the comparison indicates that the requested VQ level equals the minimum VQ level. In the examples depicted in FIG. 3, the priority levels of client video streams associated with VQ levels 31a, 32a and 33a have all been increased as indicated by the small circles.

The embodiment described above illustrates a method that compares each requested VQ level to a minimum VQ level. In yet another embodiment, a method compares each requested VQ level to a threshold VQ level in order to adjust the priority of a client video stream within a HAS video stream.

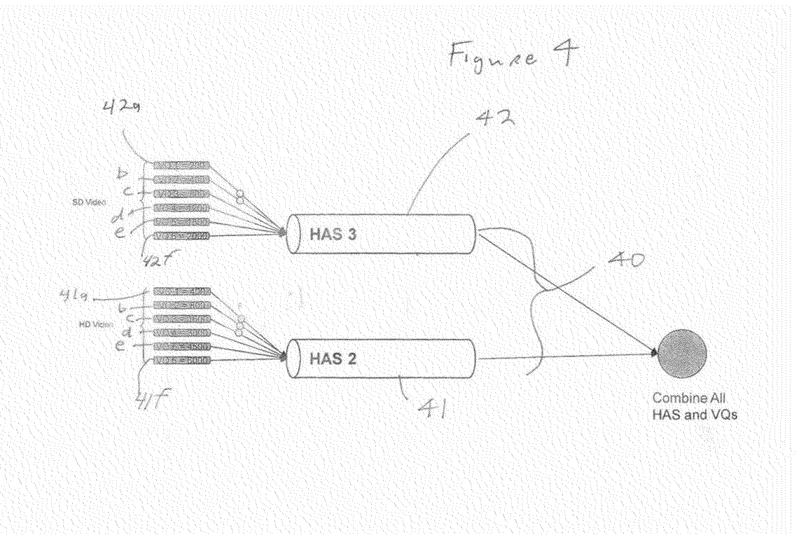

FIG. 4 depicts an access link 40 that comprises two HAS video streams 41 and 42. Further, each HAS video stream comprises one or more client video streams. FIG. 4 also depicts a plurality of VQ levels 41a through 41f, and 42a through 42f that may be associated with a client video stream within stream 41 or 42, respectively. In accordance with an embodiment of the invention, fairness and stability among video streams may be increased by adjusting the priority of those client video streams within each HAS videos stream 41, 42 that are at, or below, a threshold VQ value/level to ensure that the bandwidth of the client video streams are maintained at a rate associated with a threshold VQ level. By doing so, the bandwidth of the adjusted client video streams is guaranteed not to fall below a rate associated with the threshold VQ level.

In more detail, the following description sets forth a method for adjusting the priority associated with a client video stream within an HAS video stream according to an additional embodiment of the invention. To begin, the system 2 may be operable to receive a message (e.g., message 201 shown in FIG. 2) comprising a requested VQ value or level for a client video stream within a HAS video stream (e.g., stream 41 or 42) from the client-side system 4. For each client video stream, a separate message may be received at the system 2. Either before or after receiving each requested VQ value the system 2 (e.g., HAS originating system) may be operable to apply a desired bandwidth, notch percentage. For example, in one embodiment of the invention, the desired bandwidth notch percentage may be selected from a plurality of fractional values, such as values in the range of 0.0 to 1.0 (e.g., 0.25 and 0.50). Once the desired bandwidth notch percentage has been determined, the system 2 may be further operable to apply the selected desired bandwidth notch percentage to a desired VQ value in order to determine a desired bandwidth notch percentage factor (i.e., a bandwidth factor). Thereafter, a threshold VQ level may determined from the desired bandwidth notch percentage factor. In one embodiment, a threshold VQ level (bandwidth) may be a level below the desired bandwidth notch percentage factor. In a particular embodiment the threshold VQ level is one level below the desired bandwidth notch percentage factor.

Upon determining the threshold VQ level, the system 2 may be further operable to compare a requested, received VQ level to the threshold VQ value/level of those client video streams within each HAS video stream whose priority should be adjusted. When a given comparison indicates that a requested VQ level, associated with a given client video stream within a HAS video stream, is at, or below, the threshold VQ level, then the system 2 is yet further operable to adjust a priority assigned to the given client video stream to ensure that the bandwidth of the client video stream is maintained at a rate associated with the threshold VQ level. More particularly, the system 2 may be operable to increase the priority assigned to the client video stream when the comparison indicates that the requested VQ level is, at or below, the threshold VQ level. In the examples depicted in FIG. 4, the priority levels of client video streams associated with VQ levels 41a through 41c and 42a and b have all been increased as indicated by the small circles.

It was noted above that the threshold VQ value or level is determined in part from a received, desired VQ value or level. In general, in the embodiments of the invention discussed herein, it should be understood that although a desired VQ value or level may be received from a client-side device within system 4, in an alternative embodiment the desired VQ value or level may be pre-provisioned by the system 2. Yet further, although the desired VQ value or level may be received by the system 2 from a user or client-side system 4 within a message that is sent in close proximity to the time that the desired VQ value will be utilized to adjust a CIR level or priority level, in an alternative embodiment of the present invention a desired VQ value or level may not be received in close proximity to the time that it is used to adjust a CIR level or a priority level. In such an instance the desired VQ value or level may be stored by the system 2, for example, for later application or usage in adjusting a CIR level or a priority level, for example.

The present inventors also discovered that the priority-based methods discussed above may be varied to avoid instability between client video streams due to unexpected effects that might occur when the priority of a given client video stream is changed. In an embodiment of the invention the priority based methods may additionally include a “smoothing” feature. In more detail, rather than adjust the priority assigned to, or associated with, an entire client video stream, some packets within a chunk of such a stream may have their priority adjusted while other packets within the chunk may not have their priority adjusted.

In an embodiment of the invention, a method for adjusting the priority associated with a client video stream within an HAS video stream may comprise, for example, receiving at system 2 a message comprising a requested VQ level or value for a client video stream within a HAS video stream comprising a plurality of portions (chunks) from a client-side system 4 or a device within such a system, comparing the requested VQ level to a desired bandwidth percentage factor, and adjusting a priority assigned to some packets within each portion (chunk) from a first priority to a second priority based on the comparison.

More particularly, in an additional embodiment of the invention the priority level or value associated with some packets may be increased when the comparison indicates that the requested VQ level is at, or above, the desired bandwidth percentage factor.

Once an adjustment has been made, the system 2 may be operable to send packets within a portion (chunk) having the second assigned priority to an access device after a round trip delay period has elapsed, measured from the time packets having the first assigned priority were sent. This prevents the packets with the second assigned priority from arriving at the access device 3, for example, before the packets assigned with the first priority (i.e., out of order). This may occur when the second priority packets experience a shorter delay or a less congested pathway, than the first priority packets. At the access device 3, the device 3 may be operable to first receive the packets having the first assigned priority and, may be further operable to subsequently receive the packets having the second assigned priority after a round trip delay period has elapsed.

In embodiments of the invention, additional methods and related systems may be provided to adjust a CIR when the system 2 determines that a bandwidth notch percentage factor has been set too low or too high for one or more HAS video streams.

For example, in one embodiment of the invention, system 2 may be operable to measure a total throughput associated with one or more HAS video streams of an access link and determine a threshold VQ level for each one of the one or more HAS video streams based on a desired VQ quality level associated with each of the HAS video streams and a current, desired bandwidth notch percentage, for example. In addition to determining individual threshold VQ levels, in a further embodiment of the invention the system 2 (e.g., HAS originating system) may be operable to sum the determined, threshold VQ levels to determine a total threshold bandwidth for the one or more HAS video streams (i.e. all of the HAS streams) of the access link between the access device 3 and client-side system 4. Thereafter, the system 2 may compare the total, measured throughput to the total threshold bandwidth. If the comparison results in a determination that the total, measured throughput is greater than the total threshold bandwidth, then the system 2 may be further operable to determine a next, threshold VQ level for each of the one or more HAS video streams based on a desired VQ quality level for each HAS video stream and a next desired bandwidth notch percentage, wherein the next desired bandwidth notch percentage is greater than the current desired bandwidth notch percentage. Thereafter, the system 2 may be operable to sum the next determined, threshold VQ levels to determine a next, total threshold bandwidth, and then once again complete a comparison. This time the comparison is between the total, measured throughput to the next, total threshold bandwidth. Said another way, as long as the next desired bandwidth notch percentage is greater than the current desired bandwidth notch percentage, then the system 2 may be operable to continue to: (i) determine a threshold VQ level for each of the one or more HAS video streams based on the desired VQ quality level for each HAS video stream and a next, highest desired bandwidth notch percentage, wherein a next, highest desired bandwidth notch percentage is greater than a current desired bandwidth notch percentage; (ii) sum the determined, threshold VQ levels to determine a next, total threshold bandwidth; and (iii) compare the total, measured throughput to the next, total threshold bandwidth, when the comparison indicates that the total, measured throughput is greater than the last determined value of the previously determined, total threshold bandwidth.

When the comparison indicates that the total, measured throughput is less than or equal to the determined, total threshold bandwidth, then the system 2 may be operable to send a message, to increase the CIR for the HAS video streams associated with the access link between the access device 3 and client-side device 4 to a level equal to the total threshold bandwidth.

To determine whether or not this total, measured throughput is acceptable based on previously provided desired VQ levels associated with the HAS video streams, in one embodiment of the invention, threshold VQ levels for each HAS video stream are determined based on the previously received desired VQ levels and a stored current, desired bandwidth notch percentage. These threshold VQ levels are then summed to determine a total threshold bandwidth. This bandwidth is compared to the total threshold throughput associated with the HAS video streams (e.g., streams 31-33 in FIG. 3).

For example, assume desired VQ levels for HAS video streams 31 through 33 are 4 megabits, 6 megabits and 4 megabits, respectively. Assume further that in accordance with an embodiment of the invention, a current, desired bandwidth percentage is 0.25. Applying the current, desired bandwidth threshold bandwidth percentage to each of the desired VQ levels results in threshold VQ levels of 1, 1.5 and 1 megabit, respectively. Summing each of these levels results in a total threshold bandwidth of 3.5 megabits. This total, threshold bandwidth may then be compared to a measured, total throughput. If the measured throughput is greater than the currently summed total threshold bandwidth then the process is repeated and a new, or next desired bandwidth notch percentage is completed. That is, if the system 2 determines that a bandwidth notch percentage is set too low for the HAS video streams, it may increase the percentage to allow the HAS video streams to receive additional traffic.

Conversely, sometimes the desired bandwidth notch percentage has been set too high. If so, the present invention provides for methods and related systems for reducing the notch percentage and an associated CIR. In particular, one embodiment of the invention may comprise: measuring packet loss rate information that includes packet loss rates associated with one or more HAS video streams via a message similar to message 2200 in FIG. 1 of an access link at the system 2 (e.g. HAS originating system); and sending a message (e.g., message 2300) to access device 3, for example, to reduce a CIR when a measured packet loss rate is greater than, or equal to, an elevated rate, and an estimated, maximum rate.

In more detail, in an embodiment of the invention the system 2 may be operable to adjust the desired bandwidth notch percentage level by receiving packet loss rate information (at a HAS originating system, for example) that indicates packet loss rates associated with an access device traffic queue (e.g., Internet traffic queue), and comparing the received packet loss rate(s) indicated by this information to an elevated rate. The elevated rate is rate that may be tolerated by the system 2, but which, nonetheless indicates a rising packet loss rate. If this first comparison indicates that the received packet loss rate is greater than the elevated rate than the system 2 may need to adjust the CIR at the access device 3. In an embodiment of the invention, the system 2 may be operable to complete an additional comparison in order to determine how much of an adjustment needs to be made. In particular, a comparison of the packet loss rate indicated by the received information to the estimated, maximum rate. In an embodiment of the invention, when the packet loss rate is greater than, or equal to, the elevated rate, but less than the estimated, maximum rate then the system 2 may be operable to reduce a current desired bandwidth notch percentage to a reduced, desired bandwidth notch percentage (e.g., by one level). If, however, the received packet loss rate is greater than, or equal to, the estimated, maximum rate then the system 2 may be operable to reduce the current desired bandwidth notch percentage to a minimum, desired bandwidth notch percentage.

Yet further, once an adjusted desired bandwidth notch percentage has been determined (e.g., either a reduced percentage or a minimum percentage), the system 2 may be further operable to determine either: (a) a reduced, threshold VQ level for one or more HAS video streams within an access link associated with the access device 3 based on desired VQ quality levels for each of the HAS video streams previously sent to the system 2 and the adjusted, reduced, desired bandwidth notch percentage; or (b) a minimum, threshold VQ level for the one or more HAS video streams within a given access link based on the desired VQ quality levels for each of the HAS video streams and the adjusted, minimum, desired bandwidth notch percentage. Thereafter, the system 2 may be operable to sum the determined, reduced threshold VQ levels (or the minimum, threshold levels) to determine a total, reduced threshold bandwidth (or a total, minimum threshold bandwidth, notch percentage factor when the received packet loss rate information indicates the packet loss is greater than, or equal to, the estimated, maximum rate).

After such a sum has been determined, the system 2 may be operable to send a message to decrease the CIR associated with the access link for a HAS traffic class that includes the HAS video streams to a level equal to the total, reduced threshold bandwidth. For example, the message may instruct the access device 3 to decrease the CIR to a level equal to the total, reduced threshold bandwidth, or to decrease the CIR associated with the given access link to a level equal to the total, minimum desired bandwidth, notch percentage, for all of the HAS streams (when the received packet loss rate information indicates the packet loss is greater than, or equal to, the estimated, maximum rate then the system).

Though the description above has set forth some examples of methods and systems of the present invention, the scope of the present invention is best determined by the claims that follow.

We claim:

1. A method for adjusting a committed information rate (CIR) comprising:
receiving, at an http adaptive streaming (HAS) originating system, packet loss rate information associated with an Internet traffic queue; and
sending a message to an access device to adjust a CIR associated with a HAS traffic queue and the Internet traffic queue.

2. The method as in claim 1 wherein the access device comprises a border network gateway (BNG).

3. The method as in claim 1 wherein the access device comprises a DSLAM.

4. The method as in claim 1 wherein the access device comprises a FTTH node.

5. The method as in claim 1 wherein the HAS originating system comprises a CDN delivery server.

6. The method as in claim 1 wherein the HAS originating system comprises an origin server.

7. The method as in claim 1 wherein the HAS originating system comprises a DVR node.

8. The method as in claim 1 further comprising adjusting the CIR associated with the HAS traffic queue and Internet traffic queue.

9. The method as in claim 1 further comprising:
receiving the message to adjust the CIR;
comparing an adjusted CIR to an available CIR associated with the HAS traffic queue and Internet traffic queue;
maintaining a stored, current CIR when the comparison indicates the adjusted CIR exceeds the available CIR; and
sending a message indicating that the access device cannot meet the adjusted CIR to the HAS originating system.

10. A method for adjusting a priority associated with a client video stream within an http adaptive streaming (HAS) video stream comprising:
receiving a message from a client side system, comprising a requested video quality (VQ) level for a client video stream within a HAS video stream;
comparing the requested VQ level to a minimum VQ level; and
adjusting a priority assigned to the client video stream when the comparison indicates that the requested VQ level equals the minimum VQ level.

11. The method as in claim 10 further comprising increasing the priority assigned to the client video stream when the comparison indicates that the requested VQ level equals the minimum VQ level.

12. A method for adjusting a priority associated with a client video stream within an http adaptive streaming (HAS) video stream comprising:
receiving a message comprising a requested video quality (VQ) level for a client video stream within a HAS video stream;
applying a desired bandwidth notch percentage to a desired VQ value associated with the HAS video stream to determine a desired bandwidth, notch percentage factor;
determining a threshold VQ level from the desired bandwidth, notch percentage factor;
comparing the requested VQ level to the threshold VQ level; and
adjusting a priority assigned to the client video stream when the comparison indicates that the requested VQ level is at, or below, the threshold VQ level.

13. The method as in claim 12 further comprising applying the desired bandwidth notch percentage at a HAS originating system.

14. The method as in claim 13 wherein the HAS originating system comprises an origin server.

15. The method as in claim 13 wherein the HAS originating system comprises a DVR node.

16. The method as in claim 13 wherein the HAS originating system comprises a CDN delivery server.

17. The method as in claim 12 further comprising increasing the priority assigned to the client video stream when the comparison indicates that the requested VQ level is at, or below, the threshold VQ value.

18. The method as in claim 12 further comprising receiving the desired VQ level for the HAS video stream from a client side system.

19. The method as in claim 12 further comprising selecting the desired bandwidth, notch percentage from a plurality of fractional values.

20. The method as in claim 19 wherein the fractional values are selected from a range of 0 to 1.0.

21. A method for adjusting a priority associated with a client video stream within an http adaptive streaming (HAS) video stream comprising:
receiving a message comprising a requested video quality (VQ) level for a client video stream comprising a plurality of portions within a HAS video stream;
comparing the requested VQ level to a desired bandwidth, notch percentage factor; and
adjusting a priority assigned to some packets within each portion of the client video stream from a first assigned priority to a second assigned priority based on the comparison.

22. The method as in claim 21 further comprising:
sending the packets having the second assigned priority to an access device after a round trip delay period has elapsed.

23. The method as in claim 21 further comprising:
sending packets having the first assigned priority to an access device; and
sending the packets having the second assigned priority to the access device after a round trip delay period has elapsed.

24. The method as in claim 21 further comprising receiving the message at a HAS originating system.

25. A method for adjusting a desired bandwidth, notch percentage at an http adaptive streaming (HAS) originating system comprising:
measuring a total throughput associated with one or more HAS video streams of an access link;
determining a threshold video quality (VQ level) for each of the one or more HAS video streams based on a desired VQ quality level for each HAS video stream and a current, desired bandwidth notch percentage;
summing the determined, threshold VQ levels to determine a total threshold bandwidth for the one or more HAS video streams of the access link;
comparing the total, measured throughput to the total threshold bandwidth;
determining a next, threshold VQ level for each of the one or more HAS video streams based on a desired VQ quality level for each HAS video stream and a next desired bandwidth notch percentage, wherein the next desired bandwidth notch percentage is greater than the current desired bandwidth notch percentage, when the comparison indicates that the total, measured throughput is greater than the total threshold bandwidth;
summing the next determined, threshold VQ levels to determine a next, total threshold bandwidth;
comparing the total, measured throughput to the next, total threshold bandwidth; and
sending a message, to increase the committed information rate (CIR) for the one or more HAS video streams associated with the access link to a level equal to the total threshold bandwidth.

26. The method as in claim 25 further comprising:
continuing to determine a threshold VQ level for each of the one or more HAS video streams based on the desired VQ quality level for each HAS video stream and a next, highest desired bandwidth notch percentage, wherein the next, highest desired bandwidth notch percentage is greater than the current desired bandwidth notch percentage, when the comparison indicates that the total, measured throughput is greater than the determined, total threshold bandwidth;
continuing to sum the determined, threshold VQ levels to determine a next, total threshold bandwidth, when the comparison indicates that the total, measured throughput is greater than the determined, total threshold bandwidth; and
continuing to compare the total, measured throughput to the next, total threshold bandwidth, when the comparison indicates that the total, measured throughput is greater than the determined, total threshold bandwidth.

27. The method as in claim 26 further comprising measuring the total throughput associated with the one or more HAS video streams at a HAS originating system.

28. A method for adjusting a desired bandwidth notch level at an http adaptive streaming (HAS) originating system comprising:
receiving, at a HAS originating system, packet loss rate information that indicates a packet loss rate associated with an access device, traffic queue;
comparing the packet loss rate to an elevated rate;
comparing the packet loss rate to an estimated, maximum rate when the received packet loss rate is greater than the elevated rate;
reducing a current desired bandwidth notch percentage to a reduced, desired bandwidth notch percentage when the packet loss rate is greater than, or equal to, the elevated rate, but less than the estimated, maximum rate;
determining a reduced, threshold video quality (VQ level) for one or more HAS video streams within an access link associated with the access device based on a desired VQ quality level for each of the HAS video streams and the reduced, desired bandwidth notch percentage;
summing the determined, reduced threshold VQ levels to determine a total, reduced threshold bandwidth; and
sending a message, to decrease a committed information rate (CIR) associated with the access link for a HAS traffic class that includes the HAS video streams to a level equal to the total, reduced threshold bandwidth.

29. The method as in claim 28 wherein the access device, traffic queue comprises an Internet traffic queue.

30. The method as in claim 28 further comprising:
reducing a current desired bandwidth notch percentage to a minimum, desired bandwidth notch percentage when the packet loss rate is greater than or equal the elevated rate, and the estimated, maximum rate;
determining a minimum, threshold VQ level for one or more HAS video streams to a given access link based on a desired VQ quality level for each of the HAS video streams and the minimum, desired bandwidth notch percentage;
summing the determined, minimum threshold VQ levels to determine a total, minimum threshold bandwidth, notch percentage;
sending a message, to decrease a committed information rate (CIR) associated with the given access link to a level equal to the total, minimum desired bandwidth, notch percentage, for the HAS video streams.

31. A method for adjusting the video quality (VQ) level associated with http adaptive streaming (HAS), video streams comprising:
selecting a VQ level for a client video stream within a HAS video stream, wherein the selected VQ level is above a minimum VQ level; and
sending a message comprising the selected VQ level to a HAS originating system, wherein the system guarantees the selected VQ level.

32. The method as in claim 31 further comprising:
selecting the minimum VQ level for the client video stream within the HAS video stream; and
sending a message comprising the selected, minimum VQ level to the HAS originating system, wherein the system guarantees the selected minimum VQ level.

33. The method as in claim 31 further comprising:
selecting a VQ level similar to Internet traffic for the client video stream; and
sending a message comprising the selected VQ level similar to the Internet traffic to the HAS originating system.

34. A system for adjusting a committed information rate (CIR) comprising: a HAS originating system operable to,
receive packet loss rate information associated with an Internet traffic queue; and
send a message to an access device to adjust a CIR associated with a HAS traffic queue and the Internet traffic queue.

35. The system as in claim 34 wherein the access device comprises a border network gateway.

36. The system as in claim 34 wherein the access device comprises a DSLAM.

37. The system as in claim 34 wherein the access device comprises a FTTH node.

38. The system as in claim 34 wherein the HAS originating system comprises a CDN delivery server.

39. The system as in claim 34 wherein the HAS originating system comprises an origin server.

40. The system as in claim 34 wherein the HAS originating system comprises a DVR node.

41. The system as in claim 34, further comprising an access device operable to adjust the CIR associated with the HAS traffic queue and Internet traffic queue.

42. The system as in claim 34, further comprising an access device operable to:
receive the message to adjust the CIR;
compare an adjusted CIR to an available CIR associated with the HAS traffic queue and Internet traffic queue;
maintain a stored, current CIR when the comparison indicates the adjusted CIR exceeds the available CIR; and
send a message indicating that the access device cannot meet the adjusted CIR to the HAS originating system.

43. A system for adjusting a priority associated with a client video stream within an http adaptive streaming (HAS) video stream comprising:
a HAS originating system operable to,
receive a message from a client side system, comprising a requested video quality (VQ) level for a client video stream within a HAS video stream;
compare the requested VQ level to a minimum VQ level; and
adjust a priority assigned to the client video stream when the comparison indicates that the requested VQ level equals the minimum VQ level.

44. The system as in claim 43, wherein the HAS originating system is further operable to increase the priority assigned to the client video stream when the comparison indicates that the requested VQ level equals the minimum VQ level.

45. A system for adjusting the priority associated with a client video stream within an http adaptive streaming (HAS) video stream comprising:
a HAS originating system operable to,
receive a message comprising a requested video quality (VQ) level for a client video stream within a HAS video stream;
apply a desired bandwidth notch percentage to a desired VQ value associated with the HAS video stream to determine a desired bandwidth, notch percentage factor;
determine a threshold VQ level from the desired bandwidth, notch percentage factor;
compare the requested VQ level to the threshold VQ level; and
adjust a priority assigned to the client video stream when the comparison indicates that the requested VQ level is at, or below, the threshold VQ level.

46. The system as in claim 45 wherein the HAS originating system comprises an origin server.

47. The system as in claim 45 wherein the HAS originating system comprises a DVR node.

48. The system as in claim 45 wherein the HAS originating system comprises a CDN delivery server.

49. The system as in claim 45, wherein the HAS originating system is further operable to increase the priority assigned to the client video stream when the comparison indicates that the requested VQ level is at, or below, the threshold VQ value.

50. The system as in claim 45, wherein the HAS originating system is further operable to receive the desired VQ level for the HAS video stream from a client side system.

51. The system as in claim 45, wherein the HAS originating system is further operable to select the desired bandwidth, notch percentage from a plurality of fractional values.

52. The system as in claim 51 wherein the fractional values are selected from a range of 0.0 to 1.0.

53. A system for adjusting the priority associated with a client video stream within an http adaptive streaming (HAS) video stream comprising:
a HAS originating system operable to,
receive a message comprising a requested video quality (VQ) level for a client video stream comprising a plurality of portions within a HAS video stream;
compare the requested VQ level to a desired bandwidth, notch percentage factor; and
adjust a priority assigned to some packets within each portion of the client video stream from a first assigned priority to a second assigned priority based on the comparison.

54. The system as in claim 53, wherein the HAS originating system is further operable to send the packets having the second assigned priority to an access device after a round trip delay period has elapsed.

55. The system as in claim 53, wherein the HAS originating system is further operable to:
send packets having the first assigned priority to an access device; and
send the packets having the second assigned priority to the access device after a round trip delay period has elapsed.

56. The system as in claim 53 further comprising an access device operable to receive the packets having the first assigned priority and operable to receive the second assigned priority after a round trip delay period has elapsed.

57. A system for adjusting a desired bandwidth, notch percentage comprising:
a HAS originating system operable to,
measure a total throughput associated with one or more HAS video streams of an access link;
determine a threshold video quality (VQ level) for each of the one or more HAS video streams based on a desired VQ quality level for each HAS video stream and a current, desired bandwidth notch percentage;
sum the determined, threshold VQ levels to determine a total threshold bandwidth for the one or more HAS video streams of the access link;
compare the total, measured throughput to the total threshold bandwidth;
determine a next, threshold VQ level for each of the one or more HAS video streams based on a desired VQ quality level for each HAS video stream and a next desired bandwidth notch percentage, wherein the next desired bandwidth notch percentage is greater than the current desired bandwidth notch percentage, when the comparison indicates that the total, measured throughput is greater than the total threshold bandwidth;
sum the next determined, threshold VQ levels to determine a next, total threshold bandwidth;
compare the total, measured throughput to the next, total threshold bandwidth; and
send a message, to increase the committed information rate (CIR) for the one or more HAS video streams associated with the access link to a level equal to the total threshold bandwidth.

58. The system as in claim 57, wherein the HAS originating system is further operable to:
continue to determine a threshold VQ level for each of the one or more HAS video streams based on the desired VQ quality level for each HAS video stream and a next, highest desired bandwidth notch percentage, wherein the next, highest desired bandwidth notch percentage is greater than the current desired bandwidth notch percentage, when the comparison indicates that the total, measured throughput is greater than the determined, total threshold bandwidth;
continue to sum the determined, threshold VQ levels to determine a next, total threshold bandwidth, when the comparison indicates that the total, measured throughput is greater than the determined, total threshold bandwidth; and
continue to compare the total, measured throughput to the next, total threshold bandwidth, when the comparison indicates that the total, measured throughput is greater than the determined, total threshold bandwidth.

59. A system for adjusting a desired bandwidth notch level comprising:
an http adaptive streaming (HAS) originating system operable to,
receive packet loss rate information that indicates a packet loss rate associated with an access device, traffic queue;
compare the packet loss rate to an elevated rate;
compare the packet loss rate to an estimated, maximum rate when the received packet loss rate is greater than the elevated rate;
reduce a current desired bandwidth notch percentage to a reduced, desired bandwidth notch percentage when the packet loss rate is greater than, or equal to, the elevated rate, but less than the estimated, maximum rate;
determine a reduced, threshold video quality (VQ level) for one or more HAS video streams within an access link associated with the access device based on a desired VQ quality level for each of the HAS video streams and the reduced, desired bandwidth notch percentage;
sum the determined, reduced threshold VQ levels to determine a total, reduced threshold bandwidth; and
send a message, to decrease a committed information rate (CIR) associated with the access link for a HAS traffic class that includes the HAS video streams to a level equal to the total, reduced threshold bandwidth.

60. The system as in claim 59 wherein the access device, traffic queue comprises an Internet traffic queue.

61. The system as in claim 59 wherein the HAS originating system is further operable to,
reduce a current desired bandwidth notch percentage to a minimum, desired bandwidth notch percentage when the packet loss rate is greater than or equal the elevated rate, and the estimated, maximum rate;
determine a minimum, threshold VQ level for one or more HAS video streams to a given access link based on a desired VQ quality level for each of the HAS video streams and the minimum, desired bandwidth notch percentage;
sum the determined, minimum threshold VQ levels to determine a total, minimum threshold bandwidth, notch percentage;
send a message, to decrease a committed information rate (CIR) associated with the given access link to a level equal to the total, minimum desired bandwidth, notch percentage, for the HAS video streams.

62. A customer portal for adjusting the video quality (VQ) level associated with http adaptive streaming (HAS), video streams, the portal comprising:
a client side portion operable to select a VQ level for a client video stream within a HAS video stream, wherein the selected VQ level is above a minimum VQ level, and send a message comprising the selected VQ level to a network side portion that is part of a HAS originating system, wherein the HAS originating system is operable to guarantee the selected VQ level.

63. The portal as in claim 62, wherein the client side portion is further operable to:
select the minimum VQ level for the client video stream within the HAS video stream; and
send a message comprising the selected, minimum VQ level to the network side portion that is part of a HAS originating system, wherein the HAS originating system is operable to guarantee the selected minimum VQ level.

64. The portal as in claim 62, wherein the client side portion is further operable to:
select a VQ level similar to Internet traffic for the client video stream; and
send a message comprising the selected VQ level similar to the Internet traffic to the HAS originating system.
